(19) United States
(12) Patent Application Publication
(10) Pub. No.: US 2017/0351107 A1
(43) Pub. Date: Dec. 7, 2017

(54) DISPLAY SYSTEM AND METHOD OF CREATING AN APPARENT THREE-DIMENSIONAL IMAGE OF AN OBJECT

(71) Applicant: GM GLOBAL TECHNOLOGY OPERATIONS LLC, Detroit, MI (US)

(72) Inventors: Thomas A. Seder, Fraser, MI (US); James A. Carpenter, Rochester Hills, MI (US); Jason E. Diehl, Washington Township, MI (US)

(73) Assignee: GM GLOBAL TECHNOLOGY OPERATIONS LLC, Detroit, MI (US)

(21) Appl. No.: 15/609,560

(22) Filed: May 31, 2017

Related U.S. Application Data
(60) Provisional application No. 62/345,231, filed on Jun. 3, 2016.

(51) Int. Cl. G02B 27/22; B60R 11/02; G01C 21/36; G06F 3/01

(52) U.S. Cl. CPC G02B 27/2292; G06F 3/013; B60R 11/0258; G01C 21/3638

(57) ABSTRACT

A method of creating an apparent three-dimensional image of an object includes determining a first position of a user, creating a first two-dimensional image of the object, determining a second position of the user that is different from the first position, creating a second two-dimensional image of the object that is different from the first two-dimensional image, presenting the first two-dimensional image to the user only when the user is disposed in the first position, and presenting the second two-dimensional image to the user only when the user is disposed in the second position to thereby create the apparent three-dimensional image. A display system is also disclosed.

### CROSS-REFERENCE TO RELATED APPLICATIONS

This application claims the benefit of U.S. Provisional Patent Application No. 62/345,231, filed on Jun. 3, 2016, which is hereby incorporated by reference in its entirety.

### INTRODUCTION

The disclosure relates to a display system and to a method of creating an apparent three-dimensional image of an object.

Display systems often present imagery to a user or operator of a device. Generally, the display system presents the imagery to the user on a two-dimensional display. For some applications, three-dimensional imagery may be useful. For example, transportation applications (e.g., automotive vehicles, aircraft, and trams), entertainment applications (e.g., cinema, television, and video games), communication applications (mobile devices and scientific visualization), and medical applications (diagnosis, surgical planning and control, and medical instruction) may require a user to view three-dimensional imagery on a two-dimensional display.

### SUMMARY

A method of creating an apparent three-dimensional image of an object includes determining a first position of a user, creating a first two-dimensional image of the object, and determining a second position of the user that is different from the first position. The method also includes creating a second two-dimensional image of the object that is different from the first two-dimensional image, presenting the first two-dimensional image to the user only when the user is disposed in the first position, and presenting the second two-dimensional image to the user only when the user is disposed in the second position to thereby create the apparent three-dimensional image.

Determining the first position may include tracking a location of an eye of the user. Determining the second position may include tracking the location of the eye of the user. Further, determining the first position may include monitoring a location of a head of a user, and determining the second position may include monitoring the location of the head of the user.

In one aspect, determining the first position includes measuring a first coordinate of the user along at least one of a longitudinal axis, a latitudinal axis that is perpendicular to the longitudinal axis, and a third axis that is perpendicular to both the longitudinal axis and the latitudinal axis. Further, determining the second position may include measuring a second coordinate of the user along at least one of the longitudinal axis, the latitudinal axis, and the third axis.

Presenting the first two-dimensional image may include displaying the first two-dimensional image on a display having a resolution of from 7.9 pixels per millimeter to 11.8 pixels per millimeter, a bit depth of at least 8-bit, and a color gamut that exceeds 100% of the National Television System Committee (NTSC) color standard and is less than 100% of the International Telecommunications Union Radiocommunication Sector (ITU-R) Recommendation BT.2020 color standard.

Presenting the second two-dimensional image may include not presenting an actual three-dimensional image to the user. Further, presenting the second two-dimensional image may include manipulating a monocular visual cue selected from the group consisting of parallax, kinetic depth, perspective, texture gradient, occlusion, retinal image size, and combinations thereof.

In one aspect, presenting the second two-dimensional image may include creating a motion parallax effect to fabricate an apparent depth between the first two-dimensional image and the second two-dimensional image.

In another aspect, presenting the second two-dimensional image may include creating a kinetic depth effect to fabricate an apparent depth between the first two-dimensional image and the second two-dimensional image.

In a further aspect, presenting the second two-dimensional image may include displaying the second two-dimensional image on a substantially flat display. In another aspect, presenting the second two-dimensional image may include displaying the second two-dimensional image on a curved display.

The first two-dimensional image may have at least one of a first height, a first width, a first depth, and a first locus, and the second two-dimensional image has at least one of a second height that is different from the first height; a second width that is different from the first width; a second depth that is different from the first depth; and a second locus that is different from the first locus. Further, the first two-dimensional image may have a first retinal image size and the second two-dimensional image may have a second retinal image size that is different from the first retinal image size.

In one aspect, the first two-dimensional image may have a first texture gradient and the second two-dimensional image may have a second texture gradient that is different from the first texture gradient.

Presenting the second two-dimensional image may include creating an occlusion effect to fabricate an apparent depth between the first two-dimensional image and the second two-dimensional image.

A display system configured for presenting the apparent three-dimensional image of the object to the user includes a tracker configured for determining a first position of the user and a second position of the user that is different from the first position. The display system also includes a processor in electrical communication with the tracker and configured for receiving a first electrical signal from the tracker that corresponds to the first position, and a second electrical signal from the tracker that corresponds to the second position. The display system also includes a three-dimensional rendering of the object. The processor is configured for creating a first two-dimensional image of the object from the three-dimensional rendering in response to the first electrical signal, and creating a second two-dimensional image of the object from the three-dimensional rendering that is different from the first two-dimensional image in response to the second electrical signal. The display system also includes a tangible, non-transitory memory in electrical communication with the tracker and the processor and configured for storing the three-dimensional rendering, the first two-dimensional image, and the second two-dimensional image. In addition, the display system includes a display in electrical communication with the processor. The display is configured for receiving a third electrical signal from the processor and displaying the first two-dimensional image to the user, and receiving a fourth electrical signal from the processor and displaying the second two-dimensional image to the user.

The display may be substantially flat and may have a resolution of from 7.9 pixels per millimeter to 11.8 pixels per millimeter, a bit depth of at least 8-bit; and a color gamut that exceeds 100% of the National Television System Committee (NTSC) color standard and is less than 100% of the International Telecommunications Union Radiocommunication Sector (ITU-R) Recommendation BT.2020 color standard.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of a display system configured for presenting an apparent three-dimensional image of an object to a user.

FIG. 2 is a flowchart of a method of creating the apparent three-dimensional image of FIG. 1.

### DETAILED DESCRIPTION

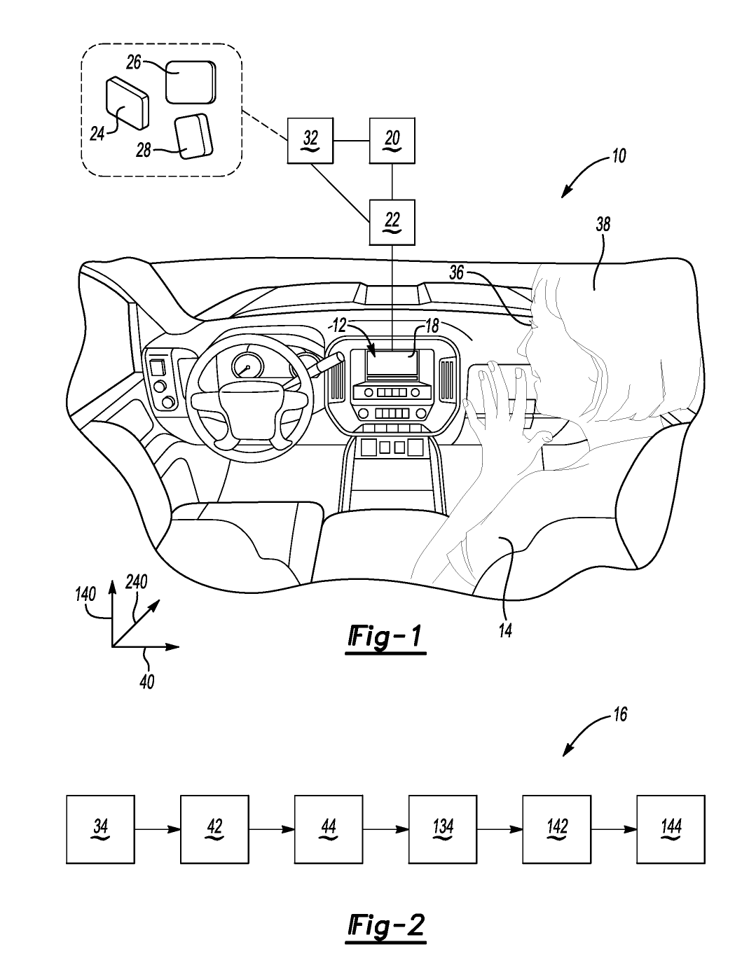

Referring to the Figures, wherein like reference numerals refer to like elements, a display system 10 configured for presenting an apparent three-dimensional image 12 of an object to a user 14 is shown generally in FIG. 1, and a method 16 of creating the apparent three-dimensional image 12 of the object is shown generally in FIG. 2. The display system 10 and the method 16 are useful for presenting the apparent three-dimensional image 12 to the user 14 on a two-dimensional display 18 (FIG. 1). That is, as used herein, the terminology “apparent three-dimensional image 12” refers to an image that is in fact a two-dimensional rendering or image of the object, but appears or is perceived to be three-dimensional based on monocular visual cues presented to the user 14, as set forth in more detail below. Therefore, the method 16 and display system 10 may be useful for applications requiring three-dimensional imagery presented on a two-dimensional surface. For example, the method 16 and display system 10 may be useful for transportation applications (e.g., automotive vehicles, construction vehicles, industrial vehicles, aircraft, and trams), entertainment applications (e.g., cinema, television, and video games), communication applications (mobile devices and scientific visualization), and medical applications (diagnosis, surgical planning and control, and medical instruction).

Referring now to FIG. 1, the display system 10 includes a tracker 20 configured for determining a first position of the user 14 and a second position of the user 14 that is different from the first position. The tracker 20 may be a head tracker or an eye tracker that is arranged to monitor head and/or eye movement of the user 14. That is, the tracker 20 may detect when the user 14 moves his head and/or eye from the first position to the second position.

The display system 10 also includes a processor 22 in electrical communication with the tracker 20 and configured for receiving a first electrical signal from the tracker 20 that corresponds to the first position, and a second electrical signal from the tracker 20 that corresponds to the second position. In addition, the display system 10 includes a three-dimensional rendering 24 of the object. For example, a camera (not shown) may capture an image of the object, and the display system 10 may create and store the three-dimensional rendering 24 of the object. Alternatively, the three-dimensional rendering 24 may be a preprocessed graphical three-dimensional model of the object.

The processor 22 is also configured for creating a first two-dimensional image 26 of the object from the three-dimensional rendering 24 in response to the first electrical signal, and creating a second two-dimensional image 28 of the object from the three-dimensional rendering 24 that is different from the first two-dimensional image 26 in response to the second electrical signal. That is, when the processor 22 receives the first electrical signal from the tracker 20 to indicate that the user 14 is in the first position, the processor 22 may create the first two-dimensional image 26 of the object from the three-dimensional rendering 24. Stated differently, the processor 22 may create a two-dimensional snapshot of the object based on a first viewpoint or first position of the user 14.

Likewise, when the processor 22 receives the second electrical signal from the tracker 20 to indicate that the user 14 is in the second position, the processor 22 may create the second two-dimensional image 28 of the object from the three-dimensional rendering 24. Stated differently, the processor 22 may create another two-dimensional snapshot of the object based on the second viewpoint of the user 14. In other words, the two-dimensional image 26, 28 that is presented to the user 14 may depend upon a viewing angle of the eyes 36 and/or head 38 of the user 14 with respect to the display 18.

With continued reference to FIG. 1, the display system 10 also includes a tangible, non-transitory memory 32 in electrical communication with the tracker 20 and the processor 22. The tangible, non-transitory memory 32 is configured for storing the three-dimensional rendering 24, the first two-dimensional image 26, and the second two-dimensional image 28. The tangible, non-transitory memory 32 may be, by way of non-limiting examples, read-only memory (ROM), flash memory, optical memory, additional magnetic memory, etc. The display system 10 may also include any required random access memory (RAM), electrically-programmable read-only memory (EPROM), a high-speed clock, analog-to-digital (A/D) and/or digital-to-analog (D/A) circuitry, and any input/output circuitry or devices, as well as any appropriate signal conditioning and buffer circuitry. Instructions for executing the method 16 (FIG. 2) of creating the apparent three-dimensional image 12 of the object may be recorded in the tangible, non-transitory memory 32 and executed as needed via the processor 22. That is, one or more individual control algorithms of the processor 22, such as instructions embodying the method 16, may be stored in the tangible, non-transitory memory 32 and automatically executed via the processor 22 to provide the apparent three-dimensional image 12.

Therefore, the display system 10 may include all software, hardware, memory, algorithms, connections, and the like necessary to monitor and control the tracker 20, the processor 22, the tangible, non-transitory memory 32, and the display 18 configured for displaying the first two-dimensional image 26 and the second two-dimensional image 28 to the user 14. Therefore, the method 16 may be embodied as software or firmware associated with the display system 10. It is to be appreciated that the display system 10 may also include any device capable of analyzing data from various inputs, e.g., the one or more sensors, comparing data, completing necessary decisions, etc. As set forth in more detail below, a possible control action resulting from execution of the method 16 is creating the apparent three-dimensional image 12 of the object.

Referring again to FIG. 1, the display system 10 also includes the display 18 in electrical communication with the processor 22. The display 18 is configured for receiving a third electrical signal from the processor 22 and displaying the first two-dimensional image 26 to the user 14, and receiving a fourth electrical signal from the processor 22 and displaying the second two-dimensional image 28 to the user 14. That is, when the display 18 receives the third electrical signal from the processor 22 to indicate that the user 14 is in the first position and that the first two-dimensional image 26 is created, the display 18 may present or display the first two-dimensional image 26 to the user 14. Stated differently, the display 18 may display the first two-dimensional snapshot of the object based on the first viewpoint or first position of the user 14. Likewise, when the display 18 receives the fourth electrical signal from the processor 22 to indicate that the user 14 is in the second position and that the second two-dimensional image 28 is created, the processor 22 may present or display the second two-dimensional image 28 to the user 14. Stated differently, the display 18 may display the second two-dimensional snapshot of the object based on the second viewpoint of the user 14.

The display 18 may be substantially flat. That is, the display 18 may have a flat screen when viewed from a viewpoint of the user 14. In another embodiment, the display 18 may be characterized as a multi-layer display having two or more two-dimensional image panes. In a further embodiment, the display 18 may be contoured or curved. The display 18 may be formed from a polymer, a vitreous material such as glass, or a composite. Further, the display 18 may be formed into a screen that is transparent and configured for displaying images, e.g., the first two-dimensional image 26 and the second two-dimensional image 28.

Further, the display 18 may be characterized as high-resolution and have highly-saturated color. More specifically, the display 18 may have a resolution of from 7.9 pixels per millimeter to 11.8 pixels per millimeter, i.e., from 200 pixels per inch to 300 pixels per inch. Further, the display 18 may have a bit depth of at least 8-bit, e.g., at least 10-bit. For example, the display 18 may have a bit depth of 12-bit or more and may be suitable for gray scale perspective shading. In addition, the display 18 may have a color gamut that exceeds 100% of the National Television System Committee (NTSC) color standard and is less than 100% of the International Telecommunications Union Radiocommunication Sector (ITU-R) Recommendation BT.2020, i.e., Rec. 2020, color standard.

Referring now to FIG. 2, in general, the method 16 of creating the apparent three-dimensional image 12 of the object includes presenting a two-dimensional perspective of the three-dimensional object according to the position of the user 14.

More specifically, the method 16 includes determining 34 the first position of the user 14. For example, determining 34 the first position may include tracking a location of an eye 36 (FIG. 1) of the user 14 with the tracker 20. Alternatively or additionally, determining 34 the first position may include monitoring a location of a head 38 (FIG. 1) of the user 14 with the tracker 20. That is, determining 34 the first position may include measuring a first coordinate of the user 14 along at least one of a longitudinal axis 40, a latitudinal axis 140 that is perpendicular to the longitudinal axis 40, and a third axis 240 that is perpendicular to both the longitudinal axis 40 and the latitudinal axis 140.

The method 16 also includes creating 42 the first two-dimensional image 26 of the object. That is, the method 16 may include taking a first snapshot of the three-dimensional rendering 24 that corresponds to the first viewpoint or first position of the user 14. For example, the three-dimensional rendering 24 of the object may be collapsed into two or more discrete two-dimensional perspective images 26, 28.

The method 16 also includes determining 134 the second position of the user 14 that is different from the first position, i.e., detecting whether the user 14 has moved or change positions. For example, determining 134 the second position may include tracking a location of the eye 36 (FIG. 1) of the user 14 with the tracker 20. Alternatively or additionally, determining 134 the second position may include monitoring a location of the head 38 (FIG. 1) of the user 14 with the tracker 20. That is, determining 134 the second position may include measuring a second coordinate of the user 14 along at least one of the longitudinal axis 40, the latitudinal axis 140, and the third axis 240.

The method 16 also includes creating 142 the second two-dimensional image 28 of the object that is different from the first two-dimensional image 26. That is, the method 16 may include taking a second snapshot of the three-dimensional rendering 24 that corresponds to the second viewpoint or second position of the user 14.

Referring again to FIG. 2, the method 16 also includes presenting 44 the first two-dimensional image 26 to the user 14 only when the user 14 is disposed in the first position, and presenting 144 the second two-dimensional image 28 to the user 14 only when the user 14 is disposed in the second position to thereby create the apparent three-dimensional image 12. Stated differently, the method 16 includes presenting a new and discrete two-dimensional image of the object to the user 14 each time the user 14 moves his head 38 and/or eyes 36. In other words, the new and discrete two-dimensional image, i.e., the second two-dimensional image 28, or a two-dimensional slice of the three-dimensional rendering 24 of the object from the current eye and/or head position is presented each time the user 14 moves.

Therefore, presenting 144 the second two-dimensional image 28 may include not presenting an actual three-dimensional image to the user 14. Instead, the method 16 may include creating only the apparent three-dimensional image 12 based on one or more actual or perceived differences between the first two-dimensional image 26 and the second two-dimensional image 28.

That is, presenting 144 the second two-dimensional image 28 may include manipulating a monocular visual cue, i.e., a cue that may provide depth information to the user 14 when the user 14 views an image, selected from the group consisting of parallax, kinetic depth, perspective, texture gradient, occlusion, retinal image size, and combinations thereof.

For example, presenting 144 the second two-dimensional image 28 may include creating a motion parallax effect to fabricate an apparent depth between the first two-dimensional image 26 and the second two-dimensional image 28. As used herein, the terminology motion parallax effect refers to a monocular visual cue in which the user 14 views an object that is comparatively closer to the user 14 as moving faster than the same object that is comparatively farther away from the user 14. Therefore, by presenting the second two-dimensional image 28 that is different from the first two-dimensional image 26 in some characteristic, e.g., a width or height or orientation or spacing from the user 14, the method 16 may create the motion parallax effect to thereby create the apparent three-dimensional image 12 of the object.

Alternatively or additionally, presenting the second two-dimensional image 28 may include creating a kinetic depth effect to fabricate the apparent depth between the first two-dimensional image 26 and the second two-dimensional image 28. As used herein, the terminology kinetic depth effect refers to a monocular visual cue in which the user 14 views a comparatively small object that is in motion as appearing to recede into a distance, and views a comparatively large object that is in motion as appearing to approach the user 14.

In another example, the first two-dimensional image 26 may alternatively or additionally have at least one of a first height, a first width, a first depth, and a first locus, and the second two-dimensional image 28 may have at least one of a second height that is different from the first height, a second width that is different from the first width, a second depth that is different from the first depth, and a second locus that is different than the first locus. That is, the method 16 may include changing a perspective of the second two-dimensional image 28 as compared to the first two-dimensional image 26. Since parallel lines converge at infinity when viewing an object, the user 14 may reconstruct a relative distance between the first two-dimensional image 26 and the second two-dimensional image 28 to thereby perceive the apparent three-dimensional image 12.

In addition or alternatively, the first two-dimensional image 26 may have a first texture gradient and the second two-dimensional image 28 may have a second texture gradient that is different from the first texture gradient. Since objects which are relatively closer to the user 14 appear more textured and detailed in terms of shape, size, and color as compared to objects which are relatively farther from the user 14, and since it becomes more difficult for the user 14 to distinguish texture for objects which are relatively farther away, presenting 144 the second two-dimensional image 28 with the second texture gradient that is different from the first texture gradient may create the apparent three-dimensional image 12.

Further, additionally or alternatively, presenting 144 the second two-dimensional image 28 may include creating an occlusion effect to fabricate the apparent depth between the first two-dimensional image 26 and the second two-dimensional image 28. As used herein, the terminology occlusion effect refers to a monocular visual cue in which a first object that is blocked from view by a second object is perceived to be behind the second object. Therefore, by presenting 144 the second two-dimensional image 28 that has a different position than the first two-dimensional image 26 the method 16 may create the occlusion effect to thereby present the apparent three-dimensional image 12.

In another example, alternatively or additionally, the first two-dimensional image 26 may have a first retinal image size and the second two-dimensional image 28 may have a second retinal image size that is different from the first retinal image size. That is, since measurement of retinal distances may decrease proportionally according to a distance from an object to the eye 36, changing the second retinal image size with respect to the first retinal image size when presenting 144 the second two-dimensional image 28 to the user 14 may create the apparent three-dimensional image 12.

Finally, presenting 44 the first two-dimensional image 26 may include displaying the first two-dimensional image 26 on the display having the resolution of from 7.9 pixels per millimeter to 11.8 pixels per millimeter, the bit depth of at least 10-bit, and the color gamut set forth above. Further, presenting 144 the second two-dimensional image 28 may include displaying the second two-dimensional image 28 on the substantially flat display 18. Alternatively, presenting 144 the second two-dimensional image 28 may include displaying the second two-dimensional image 28 on a curved display.

Therefore, the display system 10 and method 16 present clear and crisp apparent three-dimensional images 12. In particular, the difference between the first two-dimensional image 26 and the second two-dimensional image 28 may create an apparent depth between the two images 26, 28 and thereby create the apparent three-dimensional image 12. Further, the display system 10 is cost-effective and suitable for a wide range of applications which require three-dimensional images for the user 14.

While the best modes for carrying out the disclosure have been described in detail, those familiar with the art to which this disclosure relates will recognize various alternative designs and embodiments for practicing the disclosure within the scope of the appended claims.

What is claimed is:

1. A method of creating an apparent three-dimensional image of an object, the method comprising:
determining a first position of a user;
creating a first two-dimensional image of the object;
determining a second position of the user that is different from the first position;
creating a second two-dimensional image of the object that is different from the first two-dimensional image;
presenting the first two-dimensional image to the user only when the user is disposed in the first position; and
presenting the second two-dimensional image to the user only when the user is disposed in the second position to thereby create the apparent three-dimensional image.

2. The method of claim 1, wherein determining the first position includes tracking a location of an eye of the user.

3. The method of claim 2, wherein determining the second position includes tracking the location of the eye of the user.

4. The method of claim 1, wherein determining the first position includes monitoring a location of a head of the user.

5. The method of claim 4, wherein determining the second position includes monitoring the location of the head of the user.

6. The method of claim 1, wherein determining the first position includes measuring a first coordinate of the user along at least one of a longitudinal axis, a latitudinal axis that is perpendicular to the longitudinal axis, and a third axis that is perpendicular to both the longitudinal axis and the latitudinal axis.

7. The method of claim 6, wherein determining the second position includes measuring a second coordinate of the user along at least one of the longitudinal axis, the latitudinal axis, and the third axis.

8. The method of claim 1, wherein presenting the second two-dimensional image includes not presenting an actual three-dimensional image to the user.

9. The method of claim 1, wherein presenting the second two-dimensional image includes manipulating a monocular visual cue selected from the group consisting of parallax, kinetic depth, perspective, texture gradient, occlusion, retinal image size, and combinations thereof.

10. The method of claim 1, wherein presenting the second two-dimensional image includes creating a motion parallax effect to fabricate an apparent depth between the first two-dimensional image and the second two-dimensional image.

11. The method of claim 1, wherein presenting the second two-dimensional image includes creating a kinetic depth effect to fabricate an apparent depth between the first two-dimensional image and the second two-dimensional image.

12. The method of claim 1, wherein the first two-dimensional image has at least one of a first height, a first width, a first depth, and a first locus, and wherein the second two-dimensional image has at least one of a second height that is different from the first height, a second width that is different from the first width, a second depth that is different from the first depth, and a second locus that is different from the first locus.

13. The method of claim 1, wherein the first two-dimensional image has a first texture gradient and the second two-dimensional image has a second texture gradient that is different from the first texture gradient.

14. The method of claim 1, wherein presenting the second two-dimensional image includes creating an occlusion effect to fabricate an apparent depth between the first two-dimensional image and the second two-dimensional image.

15. The method of claim 1, wherein the first two-dimensional image has a first retinal image size and the second two-dimensional image has a second retinal image size that is different from the first retinal image size.

16. The method of claim 1, wherein presenting the first two-dimensional image includes displaying the first two-dimensional image on a display having a resolution of from 7.9 pixels per millimeter to 11.8 pixels per millimeter, a bit depth of at least 8-bit, and a color gamut that exceeds 100% of the National Television System Committee (NTSC) color standard and is less than 100% of the International Telecommunications Union Radiocommunication Sector (ITU-R) Recommendation BT.2020 color standard.

17. The method of claim 16, wherein presenting the second two-dimensional image includes displaying the second two-dimensional image on a substantially flat display.

18. The method of claim 16, wherein presenting the second two-dimensional image includes displaying the second two-dimensional image on a curved display.

19. A display system configured for presenting an apparent three-dimensional image of an object to a user, the display system comprising:
a tracker configured for determining a first position of the user and a second position of the user that is different than the first position;
a three-dimensional rendering of the object;
a processor in electrical communication with the tracker and configured for receiving a first electrical signal from the tracker that corresponds to the first position and a second electrical signal from the tracker that corresponds to the second position;
wherein the processor is configured for creating a first two-dimensional image of the object from the three-dimensional rendering in response to the first electrical signal and creating a second two-dimensional image of the object from the three-dimensional rendering that is different from the first two-dimensional image in response to the second electrical signal;
a tangible, non-transitory memory in electrical communication with the tracker and the processor and configured for storing the three-dimensional rendering, the first two-dimensional image, and the second two-dimensional image; and
a display in electrical communication with the processor and configured for receiving a third electrical signal from the processor and displaying the first two-dimensional image to the user, and receiving a fourth electrical signal from the processor and displaying the second two-dimensional image to the user.

20. The display system of claim 19, wherein the display is substantially flat and has:
a resolution of from 7.9 pixels per millimeter to 11.8 pixels per millimeter;
a bit depth of at least 8-bit; and
a color gamut that exceeds 100% of the National Television System Committee (NTSC) color standard and is less than 100% of the International Telecommunications Union Radiocommunication Sector (ITU-R) Recommendation BT.2020 color standard.
